(19) United States
(12) Patent Application Publication
(10) Pub. No.: US 2025/0334932 A1
(43) Pub. Date: Oct. 30, 2025

(54) METHOD FOR RAPIDLY OPTIMIZING ANTIREGULATION EFFECT OF POWER SYSTEM STABILIZER

(71) Applicants: Datang Hydropower Science & Technology Research Institute Co., Ltd., Chengdu (CN); China Datang Corporation Science and Technology General Research Institute Ltd., Beijing (CN)

(72) Inventors: Hualin LIU, Chengdu (CN); Baofu WU, Chengdu (CN); Jin YANG, Chengdu (CN); Haiku ZHANG, Chengdu (CN); Zhiding WU, Chengdu (CN); Jun DAI, Chengdu (CN); Bin CHEN, Chengdu (CN)

(73) Assignees: Datang Hydropower Science & Technology Research Institute Co., Ltd., Chengdu (CN); China Datang Corporation Science and Technology General Research Institute Ltd., Beijing (CN)

(21) Appl. No.: 19/262,438

(22) Filed: Jul. 8, 2025

Related U.S. Application Data
(63) Continuation of application No. PCT/CN2024/095847, filed on May 28, 2024.

(30) Foreign Application Priority Data
Nov. 29, 2023 (CN) 2023116249846

(51) Int. Cl. G05B 11/40; G05B 19/042

(52) U.S. Cl. CPC G05B 11/40; G05B 19/0425; G05B 2219/2639

(57) ABSTRACT

A method for rapidly optimizing an antiregulation effect of a power system stabilizer includes: Step 1, deriving specific parameters influencing the antiregulation effect of the power system stabilizer; Step 2, dividing the specific parameters influencing the antiregulation effect of the power system stabilizer into a fixed part and a regulable part; and Step3, performing a step of a voltage at a generator end for the regulable part influencing the antiregulation effect of the power system stabilizer, determining whether a numerical value of a set node after the step falls within a set range, further determining whether antiregulation exists in two channels of rotational speed w and power p of the power system stabilizer, regulating, in a case that the antiregulation exists, the regulable part, causing the numerical value of the set node to fall within the set range, and causing the antiregulation to disappear.

### CROSS-REFERENCE TO RELATED APPLICATIONS

The application claims priority to Chinese patent application No. 2023116249846, filed on Nov. 29, 2023, the entire contents of which are incorporated herein by reference.

### TECHNICAL FIELD

The present disclosure relates to the technical field of optimization of power system apparatuses, and in particular to a method for rapidly optimizing an antiregulation effect of a power system stabilizer.

### BACKGROUND

A power system stabilizer, an additional control device, is an input signal of a proportional-integral-derivative (PID) control model of an excitation system. As shown in FIG. 1, the power system stabilizer controls excitation of a synchronous motor in virtue of an automatic voltage regulator (AVR) to suppress power oscillation of a power system. An input variable may be a single variable such as speed, frequency, and power, or a combination of these single variables.

Antiregulation is a phenomenon in which a voltage of a magnetic field, a voltage of the synchronous motor and reactive power decrease (or increase) accordingly due to a regulation effect of the power system stabilizer when output power of a prime mover increases (or decreases).

An antiregulation test is aimed to check whether fluctuations of reactive power of a generator and a voltage of the generator fall within permitted ranges at a change speed of maximum output of the prime mover.

Requirements for the antiregulation test include: a change of the reactive power is less than 20% of rated reactive power, and a change of the voltage at the generator end is less than 2% of a rated voltage.

There are many excitation system manufacturers, and their respective technical strengths are different, so even for a standard power system stabilizer model implementation method, the treatment is also varied. Hardware and software of a power system stabilizer model have been relatively fixed. It is difficult to relieve an antiregulation effect of the power system stabilizer from the perspective of the excitation system manufacturers.

Accordingly, there are currently two main methods to solve the antiregulation effect of the power system stabilizer:
1. Change a regulating speed of active power: the faster the regulating speed of active power is, the stronger the antiregulation effect of the power system stabilizer is. Otherwise, the slower the regulating speed of the active power is, the less the antiregulation effect of the power system stabilizer is. By changing the regulating speed of the active power, the antiregulation effect of the power system stabilizer can be reduced.
2. Adjust parameters of the power system stabilizer: the antiregulation effect of the power system stabilizer can be influenced by many parameters. The antiregulation effect of the power system stabilizer can be reduced by regulating parameters of Ks1, Tw1, Tw2, Tw3, Tw4, Ks2, T7, Ks3, T8, T9, M and N.

Changing the regulating speed of the active power can influence the antiregulation effect of the power system stabilizer, but the most fundamental problem is the parameter problem of the power system stabilizer. In an actual test, the regulating speed of the active power is rarely changed by manual power. The regulating speed of the active power varies from person to person, and the regulating speed of each increase and decrease is difficult to unify. Accordingly, the active power is usually changed by sending instructions by a monitoring system, and once the monitoring system selects the fastest pace, the regulating speed of the active power is fixed. Thus the most important thing is to solve the issue of regulating the parameters of the power system stabilizer. There are many parameters influencing the antiregulation effect of the power system stabilizer, so it is necessary to find a method that can rapidly determine a root cause of antiregulation of the power system stabilizer and reduce a range of parameters that need to be modified, so as to improve the efficiency of the test.

### SUMMARY

A technical problem to be solved by the present disclosure is to provide a method for rapidly optimizing an antiregulation effect of a power system stabilizer. Specific parameters influencing the antiregulation effect of the power system stabilizer are derived, and a conventional solution method for the parameters influencing the antiregulation effect of the power system stabilizer is analyzed, such that the method for rapidly optimizing an antiregulation effect of a power system stabilizer with low difficulty and high efficiency is formed finally.

To solve the above technical problems, a technical solution used by the present disclosure is as follows:

A method for rapidly optimizing an antiregulation effect of a power system includes:
Step1, analyzing parameters in all elements of the power system stabilizer, and deriving specific parameters influencing the antiregulation effect of the power system stabilizer;
Step2, dividing the specific parameters influencing the antiregulation effect of the power system stabilizer into a fixed part and a regulable part; and
Step3, performing a step of a voltage at a machine end for the regulable part of the specific parameters influencing the antiregulation effect of the power system stabilizer, determining whether a numerical value of a set node after the step falls within a set range, further determining whether antiregulation exists in two channels of rotational speed w and power p of a stabilizer, regulating, in a case that the antiregulation exists, the regulable part, reducing the numerical value of the set node to the set range, and causing the antiregulation to disappear.

The set node in Step3 is a joint action node of the rotational speed w and the power p of the stabilizer, that is, a first signal superposition point (7).

A structure of a proportional-integral-derivative (PID) control model of the power system stabilizer is that an input value V1 of the rotational speed w sequentially passes through a first direct-current blocking element and a second direct-current blocking element and then acts on the first signal superposition point, an input value V2 of the power p sequentially passes through a third direct-current blocking element, a fourth direct-current blocking element, an inertial element and a power and rotational speed conversion element and then acts on the first signal superposition point, the first signal superposition point passes through a low-pass filtering element and then acts on a second signal superposition point, the inertial element acts on the second signal superposition point, and an output end of the second signal superposition point sequentially passes through a proportional amplification element, a first lead lag element, a second lead lag element and a third lead lag element and then is output.

An output end of the third lead lag element passes through an automatic on-off switch (that is, a switch capable of automatic closing and opening) and then is output.

A parameter of the first direct-current blocking element is

$$\frac{Tw 1 s}{1 + Tw 1 s} ,$$

parameter of the second direct-current blocking element is

$$\frac{Tw 2 s}{1 + Tw 2 s} ,$$

a parameter of the third direct-current blocking element is

$$\frac{Tw 3 s}{1 + Tw 3 s} ,$$

a parameter of the fourth direct-current blocking element is

$$\frac{Tw 4 s}{1 + Tw 4 s} ,$$

a parameter of the inertial element is

$$\frac{Ks 2}{1 + T 7 s} ,$$

a parameter of the power and rotational speed conversion element is Ks3, a parameter of the low-pass filtering element is

$${[ \frac{1 + T 8 s}{{( 1 + T 9 s )}^{M}} ]}^{N} ,$$

a parameter of the proportional amplification element is Ks1, a parameter of the first lead lag element is

$$\frac{T 1 s}{1 + T 2 s} ,$$

a parameter of the second lead lag element is

$$\frac{T 3 s}{1 + T 4 s} ,$$

and a parameter of the third lead lag element is

$$\frac{T 5 s}{1 + T 6 s} .$$

Tw1, Tw2, Tw3, and Tw4 are direct-current blocking time constants in seconds; Ks2 is an electric power gain with a numerical value equal to T7/Tj; T7 is an electric power integration time constant; Tj is an inertia time constant of a generator in seconds; Ks3 is an electric power and rotational speed conversion constant; T8 and T9 are band trap time constants in seconds and form a combination with M and N, the combination is the low-pass filtering element, and M and N are band trap orders; Ks1 is a gain of the power system stabilizer; and T1, T2, T3, T4, T5, and T6 are lead lag time constants in seconds (denoted as “s”). In the formulas for the above parameters, Tw1s, Tw2s, Tw3s, Tw4s, Tis, T2s, T3s, T4s, T5s, T6s, T7s, T8s, and T9s are written forms of parameter symbols Tw1, Tw2, Tw3, Tw4, T1, T2, T3, T4, T5, T6, T7, T8, and T9 followed by unit second (recorded as “s”) respectively.

Compared with the prior art, the method for quickly optimizing an antiregulation effect of a power system stabilizer provided in the present disclosure has at least the following beneficial effects:
1. The method reduces a range of an antiregulation parameter in a parameter setting test for the power system stabilizer, improves efficiency of the parameter setting test for the power system stabilizer, and saves test cost of the power system stabilizer.
2. The method optimizes a setting value of the antiregulation parameter in the parameter setting test for the power system stabilizer, relieves the antiregulation effect of the power system stabilizer, and improves an overall effect of the power system stabilizer.
3. The method shortens time of the parameter setting test for the power system stabilizer, reduces generation cost of a parameter setting test for a power system stabilizer in a power plant, and improves time of commercial generation of the power plant.

### BRIEF DESCRIPTION OF DRAWINGS

The present disclosure will be further described below with reference to the accompanying drawings and examples.

FIG. 1 is a diagram of a proportional-integral-derivative (PID) control model of an excitation system;

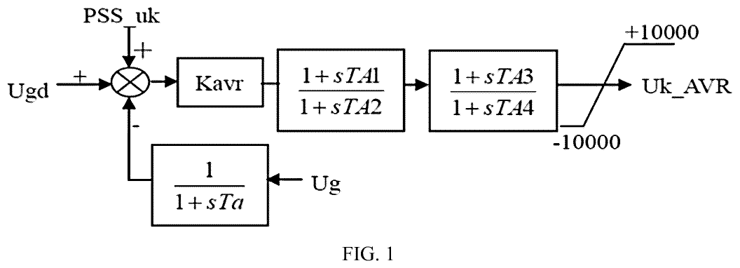

FIG. 2 is a diagram of 1A-type power system stabilizer model;

FIG. 3 is a diagram of 2A-type power system stabilizer model;

FIG. 4 is a diagram of 2B-type power system stabilizer model;

FIG. 5 is a diagram of 2A-type power system stabilizer model according to the present disclosure;

FIG. 6 is a diagram of an antiregulation effect when the method is not implemented in an example of the present disclosure;

FIG. 7 is a diagram of an antiregulation effect in a test process according to an example of the present disclosure; and

FIG. 8 is a diagram of an antiregulation effect of a unit after the method is implemented in an example of the present disclosure.

In the figures, first direct-current blocking element 1, second direct-current blocking element 2, third direct-current blocking element 3, fourth direct-current blocking element 4, inertial element 5, power and rotational speed conversion element 6, first signal superposition point 7, low-pass filtering element 8, second signal superposition point 9, proportional amplification element 10, first lead lag element 11, second lead lag element 12, third lead lag element 13, and automatic on-off switch 14.

### DETAILED DESCRIPTION OF THE EMBODIMENTS

The technical solution of the present disclosure is described in detail below in conjunction with the accompanying drawings and examples.

A method for rapidly optimizing an antiregulation effect of a power system includes:
Step1, parameters in all elements of the power system stabilizer are analyzed, and specific parameters influencing the antiregulation effect of the power system stabilizer are derived;
Step2, the specific parameters influencing the antiregulation effect of the power system stabilizer are divided into a fixed part and regulable part; and
Step3, a step of a voltage at a machine end is performed (that is, a voltage step experiment at the generator end is performed) for the regulable part of the specific parameters influencing the antiregulation effect of the power system stabilizer, whether a numerical value of a set node after the step falls within a set range is determined, whether antiregulation exists in two channels of rotational speed w and power p of the stabilizer is further determined, in a case that the antiregulation exists, the regulable part are regulated, the numerical value of the set node is reduced to the set range (that is, within the set range), and the antiregulation is caused to disappear.

The set node in Step3 is a joint action node of the rotational speed w and the power p of the stabilizer, that is, a first signal superposition point 7.

A structure of a proportional-integral-derivative (PID) control model of the power system stabilizer is that an input value V1 of the rotational speed w sequentially passes through a first direct-current blocking element 1 and a second direct-current blocking element 2 and then acts on the first signal superposition point 7, an input value V2 of the power p sequentially passes through a third direct-current blocking element 3, a fourth direct-current blocking element 4, an inertial element 5 and a power and rotational speed conversion element 6 and then acts on the first signal superposition point 7, the first signal superposition point 7 passes through a low-pass filtering element 8 and then acts on a second signal superposition point 9, the inertial element 5 also acts on the second signal superposition point 9, and an output end of the second signal superposition point 9 sequentially passes through a proportional amplification element 10, a first lead lag element 11, a second lead lag element 12 and a third lead lag element 13 and then is output.

An output end of the third lead lag element 13 passes through an automatic on-off switch 14 and then is output.

With reference to China GB/T 40591-2021 Guide for setting test of power system stabilizer, a parameter of the first direct-current blocking element 1 is

$$\frac{Tw 1 s}{1 + Tw 1 s} .$$

A parameter of the second direct-current blocking element 2 is

$$\frac{Tw 2 s}{1 + Tw 2 s} .$$

A parameter of the third direct-current blocking element 3 is

$$\frac{Tw 3 s}{1 + Tw 3 s} .$$

A parameter of the fourth direct-current blocking element 4 is

$$\frac{Tw 4 s}{1 + Tw 4 s} .$$

A parameter of the inertial element 5 is

$$\frac{Ks 2}{1 + T 7 s} .$$

A parameter of the power and rotational speed conversion element 6 is Ks3. A parameter of the low-pass filtering element 8 is

$${[ \frac{1 + T 8 s}{{( 1 + T 9 s )}^{M}} ]}^{N} .$$

A parameter of the proportional amplification element 10 is Ks1. A parameter of the first lead lag element 11 is

$$\frac{T 1 s}{1 + T 2 s} .$$

A parameter of the second lead lag element 12 is

$$\frac{T 3 s}{1 + T 4 s} .$$

A parameter of the third lead lag element 13 is

$$\frac{T 5 s}{1 + T 6 s} .$$

Tw1, Tw2, Tw3, and Tw4 are direct-current blocking time constants in seconds. Ks2 is an electric power gain with a numerical value equal to T7/Tj. T7 is an electric power integration time constant. Tj is an inertia time constant of a generator in seconds. Ks3 is an electric power and rotational speed conversion constant. T8 and T9 are band trap time constants in seconds and form a combination with M and N. The combination is the low-pass filtering element. M and N are band trap orders. Ks1 is a gain of the power system stabilizer. T1, T2, T3, T4, T5, and T6 are lead lag time constants in seconds (denoted as “s”).

In

$$\frac{Tw 1 s}{1 + Tw 1 s} , \frac{Tw 2 s}{1 + Tw 2 s} , \frac{Tw 3 s}{1 + Tw 3 s} , \frac{Tw 4 s}{1 + Tw 4 s} , \frac{Ks 2}{1 + T 7 s} , {[ \frac{1 + T 8 s}{{( 1 + T 9 s )}^{M}} ]}^{N} , \frac{T 1 s}{1 + T 2 s} , \frac{T 3 s}{1 + T 4 s} , \frac{T 3 s}{1 + T 4 s} ,$$

Tw1s, Tw2s, Tw3s, Tw4s, Tis, T2s, T3s, T4s, T5s, T6s, T7s, T8s, and T9s are written forms of parameter symbols Tw1, Tw2, Tw3, Tw4, T1, T2, T3, T4, T5, T6, T7, T8, and T9 followed by unit second (recorded as “s”) respectively.

### EXAMPLE

Unit 1 of a power plant has a rated capacity of 22.2 MVA, rated active power of 20 MW, rated reactive power of 9.63 MVar, a rated stator voltage of 10.5 kV, a rated rotational speed of 75 r/min, flywheel torque GD2 of a generator and a water turbine being 3400 t·m², and an inertia time constant Tj of 2.36 s. Parameters of a power system stabilizer (PSS) set at the beginning of a test are:
Tw1=Tw2=Tw3=T7=5 s, and Tw4=0 s, where 0 represents a path, T1=0.13 s, T2=0.02 s, T3=0.1 s, T4=0.02 s, T5=T6=0 s, T8=0.6 s, T9=0.12 s, Ks1=6, Ks2=2.12, Ks3=1, M=5, and N=1.

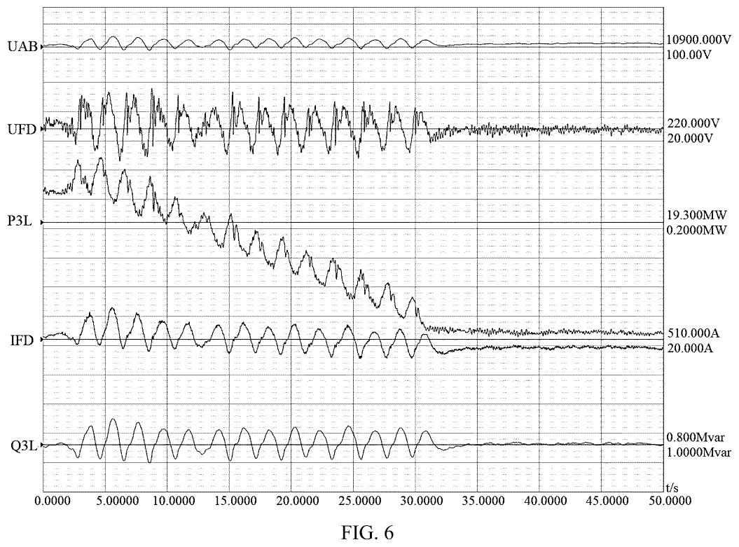

This group of parameters has a very poor test effect. Specific data are shown in FIG. 6 and Table 1.

In FIG. 6, UAB-Generator end voltage, that is, line voltage; UFD-excitation voltage; IFD-excitation current; P2L-active power; and Q2L-reactive power.

TABLE 1

| Change of | Change | Ratio of | | Ratio of | |
|---|---|---|---|---|---|
| active power | range of | change to | Change | change to | If |
| of | reactive | rated | range of | rated | regulations |
| antiregulation | power | reactive | voltage | voltage | are |
| test | (MVar) | power (%) | (V) | (%) | satisfied |
| Reduced by 4 | 4.1775 | 43.36 | 159 | 15.14 | No |
| MW | | | | | |

In the process, through recording a waveform of PSS_6, an amplitude value is 0.4, which indicates that the rotational speed w and the power P have output, but a main range of causing antiregulation has not been determined. By modifying an internal channel coefficient of an automatic electric regulator, the waveform of PSS_6 is recorded continuously. When a minimum amplitude value is 0.08, no matter how the parameters are modified, the output cannot have a smaller value. In this case, it can be determined that the amplitude value of PSS_6 is 0.08, and the channels w and P have no output 0 value.

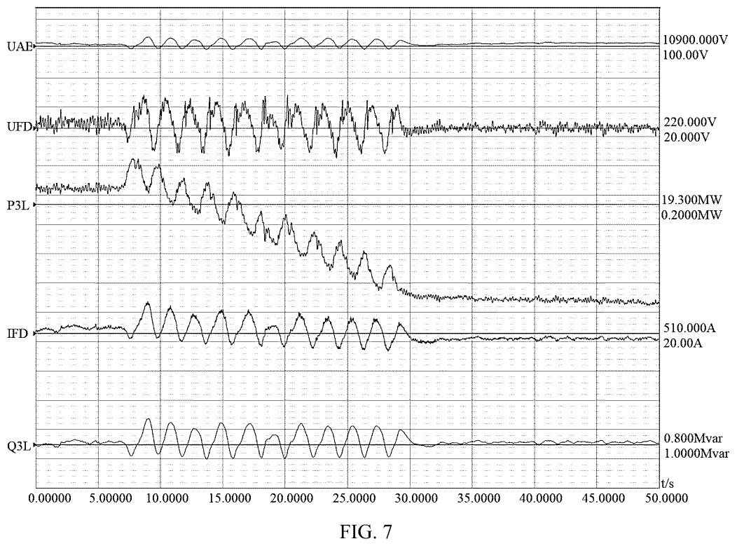

In this case, the antiregulation test is continued. It is found that an antiregulation test effect is still not good enough. Specific data are shown in FIG. 7 and Table 2.

TABLE 2

| Change of | Change | Ratio of | | Ratio of | |
|---|---|---|---|---|---|
| active power | range of | change to | Change | change to | If |
| of | reactive | rated | range of | rated | regulations |
| antiregulation | power | reactive | voltage | voltage | are |
| test | (MVar) | power (%) | (V) | (%) | satisfied |
| Reduced by 4 | 4.0716 | 42.28 | 128 | 12.19 | No |
| MW | | | | | |

By using the method of the present disclosure, since the parameters Tw1, Tw2, Tw3, Tw4 and T7 are distributed in the rotational speed w and the power P, and the outputs of the rotational speed w and the power P are 0, it can be determined that there is no problem in setting the parameters Tw, Tw2, Tw3, Tw4 and T7. Since Ks2=T7/Tj, and Tj is a fixed value, a set value of Ks2 is no problem. Then testing is performed by regulating a numerical value of Ks1, it is found that Ks1 cannot cause a large change of the antiregulation. Thus antiregulation is located in T8, T9, M and N, that is, the low-pass filtering element. Soon a group of finally used parameters of the PSS with an ideal antiregulation effect can be obtained.

Tw1=Tw2=Tw3=T7=5 s, Tw4=0 s (0 indicates a path), T1=0.13 s, T2=0.02 s, T3=0.1 s, T4=0.02 s, T5=T6=0 s, T8=0.3 s, T9=0.1 s, Ks1=6, Ks2=2.12, Ks3=1, M=3, and N=1.

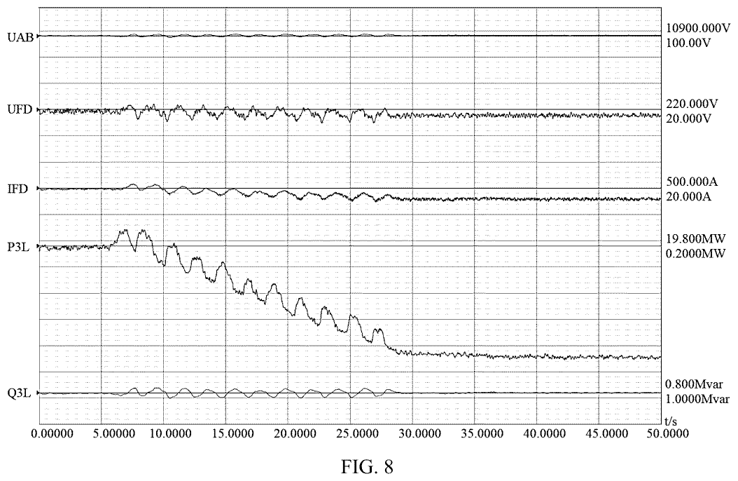

New parameters are used for an antiregulation test. An effect is very ideal. Specific data are shown in FIG. 8 and Table 3.

TABLE 3

| Change of | Change | Ratio of | | Ratio of | |
|---|---|---|---|---|---|
| active power | range of | change to | Change | change to | If |
| of | reactive | rated | range of | rated | regulations |
| antiregulation | power | reactive | voltage | voltage | are |
| test | (MVar) | power (%) | (V) | (%) | satisfied |
| Reduced by 4 | 1.089 | 11.30 | 31 | 0.295 | Yes |
| MW | | | | | |

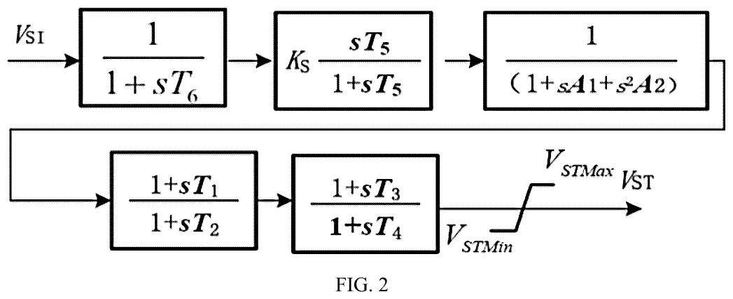

In an existing power system application, reasons why the antiregulation of the power system stabilizer cannot be eliminated are as follows:
1. As for a power system stabilizer 1A model, as shown in FIG. 2, the power system stabilizer 1A model naturally has an antiregulation effect.

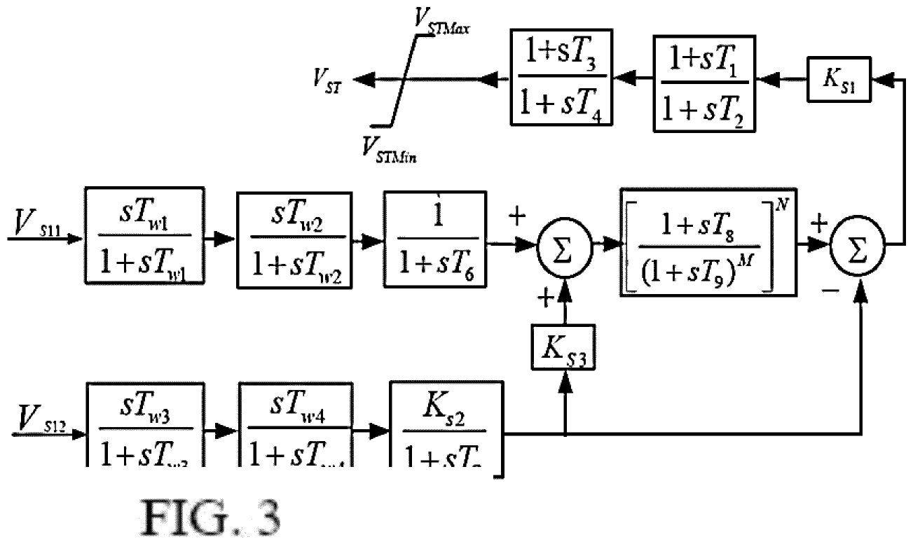

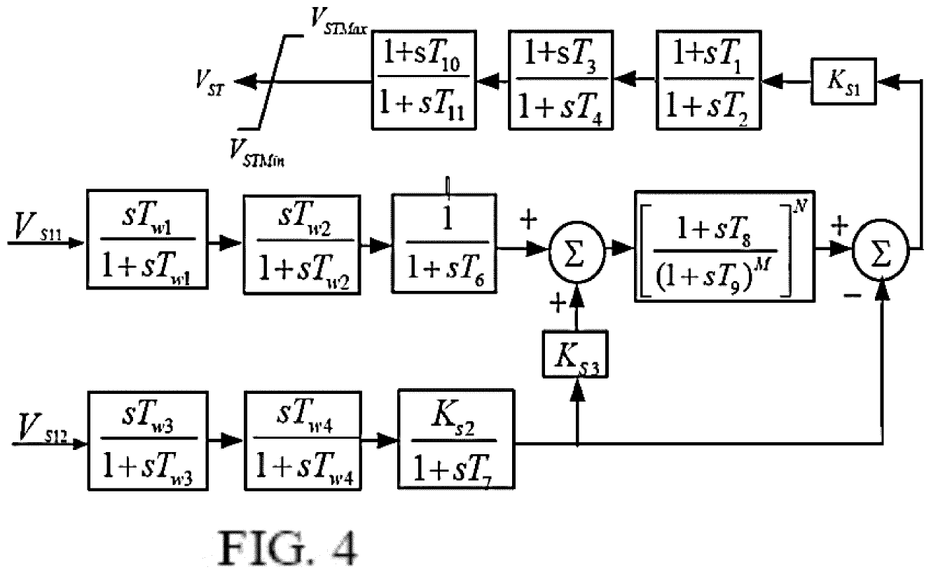

The power system stabilizer 1A model uses electric power as an input signal and is a single-input power system stabilizer. A serious reactive antiregulation effect is caused when active power is regulated. This is because when a generator normally increases or decreases the active power, a fluctuation of the active power does not belong to low frequency oscillation, but the power system stabilizer 1A model does not collect a rotation speed signal, and it is impossible to distinguish whether a numerical change of the active power is caused by a system side or a prime mover side. In this case, the power system stabilizer 1A model still has output superimposed on a rated voltage of the generator end, which leads to a reactive power antiregulation effect inevitably.
2. As for a power system stabilizer 2A/2B model, as shown in FIG. 3 and FIG. 4, the power system stabilizer 2A/2B model does not have an antiregulation effect theoretically, but the antiregulation effect actually exists.

The power system stabilizer 2A/2B model is a dual-input PSS, one input is rotational speed W, and the other input is power P. A principle is to calculate mechanical power ΔPm and electromagnetic power ΔPe of the generator by using the rotational speed W and the power, and the mechanical power and the electromagnetic power are subtracted to obtain acceleration power ΔPa of the generator. In this way, when the unit increases or decreases a load in one direction, the acceleration power is equal to zero. The power system stabilizer does not work, that is, no reactive antiregulation effect is generated. The power system stabilizer 2A/2B model can effectively suppress the antiregulation effect theoretically, but there is still an antiregulation effect in practice. There are three main reasons:
1) Processing of the rotational speed W by excitation system manufacturers is different. Some manufacturers attenuate the rotational speed internally, resulting in inaccurate sampling of a rotational speed W signal.
2) In a test process, testers set the parameters of the power system stabilizer differently due to their own technical levels and test experience.
3) In the test process, understanding of a change speed of maximum output of a prime mover is not accurate enough, which influences regulation of a change speed of the active power:
1) The testers have limited understanding of the change speed of the maximum output of the prime mover. 2) Due to limitation of actual conditions, it is difficult to test the change speed of the maximum output of the prime mover. Usually, a normal operation speed is used for regulating the output of prime mover for testing, and then a waveform of an antiregulation effect of the reactive power of the unit is recorded. Obviously, rationality of the parameters of the power system stabilizer cannot be effectively verified.

Under the condition of the prior art, the power system stabilizer has the following disadvantages:
1. The antiregulation effect of the power system stabilizer is solved by changing the regulating speed of the active power.
1) After the regulating speed of the active power is changed, requirements of the test guide for the antiregulation test may not be satisfied.
2) When the regulating speed of the active power is changed, parameters of a monitoring system or parameters of a governor need to be changed.
3) The parameters of the monitoring system and the parameters of the governor are typically not allowed to be modified or cannot be modified on site.
4) The regulating speed of the active power is changed by manual power. The regulating speed of the active power varies from person to person, and the speeds of increase and decrease are difficult to unify.
2. The parameters of the power system stabilizer are regulated to relieve the antiregulation effect of the power system stabilizer:
1) Many parameters influencing the antiregulation effect of the power system stabilizer are provided. Many parameter combinations need to be adjusted.
2) In order to determine an influence proportion of a parameter on the antiregulation effect of the power system stabilizer, repeated tests are needed.
3) Limited by the technical levels and the test experiences of the testers, a method to solve the antiregulation effect may not be found.
4) Regulating the parameters influencing the antiregulation effect of the power system stabilizer may influence effects of other functions of the power system stabilizer.

Since the power system stabilizer 1A model naturally has the antiregulation effect, the excitation system on the market has rarely used the 1A model. Some old small power plants may still have this model, but also gradually upgrade the model with requirements of the power grid. Thus only a method for rapidly optimizing the antiregulation effect of the power system stabilizer 2A/2B model is discussed herein.

1. By analyzing effects of parameters in all elements of the power system stabilizer, specific parameters influencing the antiregulation effect of the power system stabilizer are derived.

The antiregulation effect of the power system stabilizer can be influenced by many parameters. The antiregulation effect of the power system stabilizer can be reduced by regulating a regulable part of Ks1, Tw1, Tw2, Tw3, Tw4, Ks2, T7, Ks3, T8, T9, and M. Ks1 is a gain of the power system stabilizer, which is the easiest to test out. In a case that Ks1 is greater, the antiregulation effect is stronger. In a case that Ks1 is subtler, the antiregulation effect is subtler. Tw1, Tw2, Tw3, and Tw4 are direct-current blocking time constants. In a case that the direct-current blocking time constants are subtler, the antiregulation effect is subtler. In a case that the direct-current blocking time constants are greater, the antiregulation effect is stronger. Ks2 is a gain of electric power and has a numerical value equal to T7/Tj. In a case that Ks2 is greater, the antiregulation effect is stronger. In a case that Ks2 is subtler, the antiregulation effect is subtler. T7 is an electric power integration time constant. Under normal conditions, T7=Tw1=Tw2=Tw3. Tj is an inertia time constant of the generator, is determined according to moment of inertia or flywheel torque of the generator and shafting, and has a specific formula: Tj=2.74*n²*GD²/1000 Pn. Ks3 is an electric power and rotational speed conversion constant. In a case that Ks3 is less than 1, the antiregulation effect is stronger. In a case that Ks3 is equal to 1, the antiregulation effect is subtler. T8 and T9 are a ramp function (also called band trap time constants) and form a combination with M and N. The combination is the low-pass filtering element. M and N are band trap orders. Nis a fixed part and generally has a value of 1. An anti-antiregulation mechanism of the 2A/2B model is mainly dependent on a similarity between input and output signals of the ramp function. When the entire element is equal to 1, that is, T8=T9*M and N=1, the similarity is the highest, and an anti-antiregulation capacity is highest. Otherwise, the anti-antiregulation capacity is low.

2. By analyzing a conventional solution method for the parameters influencing the antiregulation effect of the power system stabilizer, shortcomings of the conventional solution method are analyzed.

From the above analysis, it can be known that many parameters influencing the antiregulation effect of the power system stabilizer are provided, and the parameters influence each other. It is very difficult to select a group of parameters to make the antiregulation effect minimum on the premise of guaranteeing that a damping ratio satisfies requirements of the regulations. In a process of regulating the parameters, a desired effect may be achieved by regulating the parameters simultaneously. Accordingly, only a trial-and-error method may be performed. That is to say, tests are performed after the parameters are regulated, and the parameters are regulated when the antiregulation effect is not ideal. The parameters need to be combined continuously for testing, the work amount is huge, and the efficiency is low.

3. Aiming at the shortcomings of the solution method, a method for rapidly optimizing an antiregulation effect of a power system stabilizer with low difficulty and high efficiency is provided.

The parameters of T8, T9, M and N are a combination, are relatively fixed, that is, T8=T9*M and N=1. Ks1 may also be fixed at a fixed value according to the damping ratio. As long as relevant design parameters of the generator are accurate, Ks2 is a fixed value. Ks3 is also a fixed value. These fixed values are 1 by default. Then Tw1, Tw2, Tw3, Tw4 and T7 are left, and these parameters are just distributed in the rotational speed w and the power p.

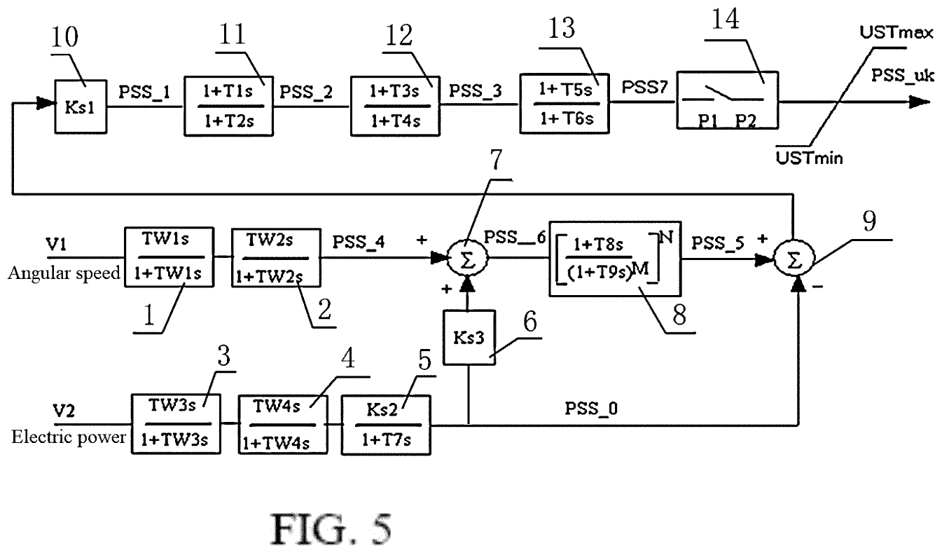

In this case, in a case that a method can rapidly determine whether the antiregulation effect exists in the rotational speed w and the power p, the efficiency of the test is greatly improved. Specifically, in a case that the active power and the reactive power are kept constant, the step of the voltage at the generator end is 2%-4%, and the waveform of PSS_6 of FIG. 5 is recorded in real time. Since the active power at the system side does not change at this time, after a voltage step, the power system stabilizer should not have an output signal, that is, a numerical value of PSS_6 should be 0 (that is, a numerical value of the set range is 0, and the numerical value of the set node after the step falls within the set range), indicating that the rotational speed w and the power p have no output, and no antiregulation effect exists. In a case that the numerical value of PSS_6 is not 0 (that is, the numerical value of the set range is 0, the value of the set node after the step falls out of the set range), it indicates that the rotational speed w and the power p have an output after superposition, and the antiregulation effect exists. That is to say, either the parameters of the two channels are inappropriate, or channel coefficients of the two channels are inappropriate. Only by regulating the numerical value of PSS_6 close to 0 after the step, it can be guaranteed that the power system stabilizer may have no antiregulation effect. Through a step test method, whether the parameters of the two channels are appropriate can be determined directly, and a range of regulating the parameters can be reduced rapidly, so as to rapidly “the power system stabilizer.

What is claimed is:

1. A method for rapidly optimizing an antiregulation effect of a power system stabilizer, comprising:
Step1, analyzing parameters in all elements of the power system stabilizer, and deriving specific parameters influencing the antiregulation effect of the power system stabilizer;
Step2, dividing the specific parameters influencing the antiregulation effect of the power system stabilizer into a fixed part and a regulable part; and
Step3, performing a step of a voltage at a machine end for the regulable part of the specific parameters influencing the antiregulation effect of the power system stabilizer, determining whether a numerical value of a set node after the step falls within a set range, further determining whether antiregulation exists in two channels of rotational speed w and power p of a stabilizer, regulating, in a case that the antiregulation exists, the regulable part, reducing the numerical value of the set node to the set range, and causing the antiregulation to disappear.

2. The method for rapidly optimizing an antiregulation effect of a power system stabilizer according to claim 1, wherein the set node in Step3 is a joint action node of the rotational speed w and the power p of the stabilizer, that is, a first signal superposition point (7).

3. The method for rapidly optimizing an antiregulation effect of a power system stabilizer according to claim 2, wherein a structure of a proportional-integral-derivative (PID) control model of the power system stabilizer is that an input value V1 of the rotational speed w sequentially passes through a first direct-current blocking element (1) and a second direct-current blocking element (2) and then acts on the first signal superposition point (7), an input value V2 of the power p sequentially passes through a third direct-current blocking element (3), a fourth direct-current blocking element (4), an inertial element (5) and a power and rotational speed conversion element (6) and then acts on the first signal superposition point (7), the first signal superposition point (7) passes through a low-pass filtering element (8) and then acts on a second signal superposition point (9), the inertial element (5) acts on the second signal superposition point (9), and an output end of the second signal superposition point (9) sequentially passes through a proportional amplification element (10), a first lead lag element (11), a second lead lag element (12) and a third lead lag element (13) and then is output.

4. The method for rapidly optimizing an antiregulation effect of a power system stabilizer according to claim 3, wherein an output end of the third lead lag element (13) passes through an automatic on-off switch (14) and then is output.

5. The method for rapidly optimizing an antiregulation effect of a power system stabilizer according to claim 3, wherein a parameter of the first direct-current blocking element (1) is
$$\frac{Tw 1 s}{1 + Tw 1 s} ,$$
a parameter of the second direct-current blocking element (2) is
$$\frac{Tw 2 s}{1 + Tw 2 s} ,$$
a parameter of the third direct-current blocking element (3) is
$$\frac{Tw 3 s}{1 + Tw 3 s} ,$$
a parameter of the fourth direct-current blocking element (4) is
$$\frac{Tw 4 s}{1 + Tw 4 s} ,$$
a parameter of the inertial element (5) is
$$\frac{Ks 2}{1 + T 7 s} ,$$
a parameter of the power and rotational speed conversion element (6) is Ks3, a parameter of the low-pass filtering element (8) is
$${[ \frac{1 + T 8 s}{{( 1 + T 9 s )}^{M}} ]}^{N} ,$$
a parameter of the proportional amplification element (10) is Ks1, a parameter of the first lead lag element (11) is
$$\frac{T 1 s}{1 + T 2 s} ,$$
a parameter of the second lead lag element (12) is
$$\frac{T 3 s}{1 + T 4 s} ,$$
and a parameter of the third lead lag element (13) is
$$\frac{T 5 s}{1 + T 6 s} .$$
